(19) United States
(12) Patent Application Publication
(10) Pub. No.: US 2006/0277371 A1
(43) Pub. Date: Dec. 7, 2006

(54) System and method to instrument references to shared memory

(75) Inventors: Robert S. Cohn, Salem, NH (US); Tipp James Moseley, McDonough, GA (US); Vijay Janapa Reddi, Andhra Pradesh (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/143,130

(22) Filed: Jun. 1, 2005

(51) Int. Cl. G06F 12/00

(52) U.S. Cl. 711/147

(57) ABSTRACT

In some embodiments, the invention involves instrumentation of computer binary code and, more specifically, dynamically identifying shared memory accesses at runtime and instrumenting the shared memory access instruction code. Some embodiments use code caching to only hold the patched instrumentation. Other embodiments use code caching to hold the entire program and instrumentation. Shared memory accesses are identified using inaccessible memory address references to cause memory faults. The fault handler may emulate instrumentation in one instance and cause a just-in-time compilation of instruction traces with instrumentation into the code cache. Other embodiments are described and claimed.

### FIELD OF THE INVENTION

An embodiment of the present invention relates generally to instrumentation of computer binary code and, more specifically, to dynamically identifying shared memory accesses at runtime and instrumenting the shared memory access instruction code.

### BACKGROUND INFORMATION

Various mechanisms exist for instrumentation of computer programs for use in debugging or performance measuring. A goal of debugging or measuring typically requires taking an existing application and inserting debug or measuring code into the original code (source or object) to observe the memory references or other resource reference. The added code can assist in an automated method of finding bugs in the computer code. Manual methods of debugging and measuring are becoming less viable as computer code becomes more complex.

Existing tools such as Rational Purify, available from Rational Corporation, a division of IBM Corporation, is an advanced runtime and memory management error detection tool. The Rational Purify tool examines memory references to identify specific classes of bugs. More information about the Rational Purify tool may be found on the public Internet URL www-306-ibm-com/software/awdtools/purifyplus/. It should be noted that dots have been replaced with dashes in URLs to avoid inadvertent creation of hyperlinks in this document. The Rational Purify tool finds bugs for single process programs, not parallel programs.

Similarly, Bistro (part of the Vtune product available from Intel Corporation), ATOM (developed by Digital Equipment Corp., now owned by Hewlett-Packard Company) and Etch (developed at University of Washington, but not publicly available) are generic tools for static instrumentation. Static instrumentation tools examine an entire program and decide in advance what code gets instrumentation and what does not. More information about the Etch tool may be found on the public Internet at URL www-cs-washington-edu/homes/bershad/Papers/etch-ntws97.pdf in an article by Romer et al., entitled “Instrumentation and Optimization of Win32/Intel Executables,” [Usenix NT Workshop, August 1997].

Some dynamic instrumentation tools currently exist, for instance, Dyninst is an Application Program Interface (API) for Runtime Code Generation. More information on Dyninst may be found on the public Internet at URL www-dyninst-org/. Another dynamic instrumentation tool is DynamoRIO available in a collaborative effort between Hewlett-Packard Laboratories and Massachusetts Institute of Technology (MIT) Laboratory for Computer Science (see URL, www-cag-lcs-mit-edu/dynamorio/). Existing dynamic tools assign a place in the program instrumentation if desired, for example, a memory instruction. The memory instruction is replaced with a branch instruction during execution and the program branches to the instrumentation. Once the instrumentation tasks are complete, the program branches back to the instruction following the branch in the original code. This is also called patching. The patch can be changed on the fly, during runtime.

While both static and dynamic instrumentation tools are used in existing systems, current technology has its disadvantages. Finding bugs in applications using parallel processors is problematic. Parallel processors typically use shared memory. A parallel program can share memory between processes by requesting that the operating system map a shared memory region into the address space of multiple processes. For the purpose of profiling and detecting errors, programmers would like to observe all the accesses to the shared area. This can be done with existing software instrumentation, where extra code is inserted into the original application binary. Before every memory read or write instruction, an instrumentation tool can insert extra code that records the effective address of the memory instruction and other data. When the program executes, it executes the instrumentation followed by the actual memory instruction. A separate tool analyzes all the reads and writes to shared memory to automatically detect bugs.

If the code is instrumented with existing tools, then every memory operation will execute the instrumented code. The best existing tools may slow the execution 25 times or more. Thus, instrumenting every memory instruction will cause the program to run very slowly. The slowdown depends on how much work is done in the instrumentation, but a typical slowdown can be a factor of 100. Since only a small percentage of the memory instructions reference shared memory, it would be more efficient to only instrument the instructions that actually reference shared memory. Unfortunately, this is not practical for existing systems. Data flow analysis can prove that a particular memory instruction only references stack, global, or heap data. However, existing systems have no practical analysis for precisely determining the data area for a high percentage of memory references.

### BRIEF DESCRIPTION OF THE DRAWINGS

The features and advantages of the present invention will become apparent from the following detailed description of the present invention in which:

FIG. 1 is a high level flow diagram illustrating a method to instrument references to shared memory, according to an embodiment of the invention;

FIG. 2 is a flow diagram for a fault handler method to instrument shared memory references, according to an embodiment of the invention;

FIG. 3 is a block diagram representing using branch analysis to generate code branching (instrumentation) in a code cache, according to an embodiment of the invention;

FIG. 4 is a further block diagram representing using branch analysis to generate code branching (instrumentation) in a code cache, according to an embodiment of the invention; and

FIG. 5 is a block diagram of an exemplary environment which may be used to house an embodiment of the invention.

### DETAILED DESCRIPTION

An embodiment of the present invention is a system and method relating to instrumentation of references to shared memory. In at least one embodiment, the present invention is intended to speed up execution time by instrumenting only shared memory references rather than all memory references. Embodiments of the present invention take advantage of instrumenting only the shared memory references in the application code and ignoring the non-shared memory references. Identifying which of the memory references are shared memory references and only instrumenting the identified code helps reduce overhead introduced by excessive instrumentation of code.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

In an embodiment, an event handler triggers a fault for a shared memory access. A just in time (JIT) compiler generates code and inserts branches and instrumentation to a code cache. When the shared memory access is referenced a second time, the instrumented code in the code cache is executed without generating another fault.

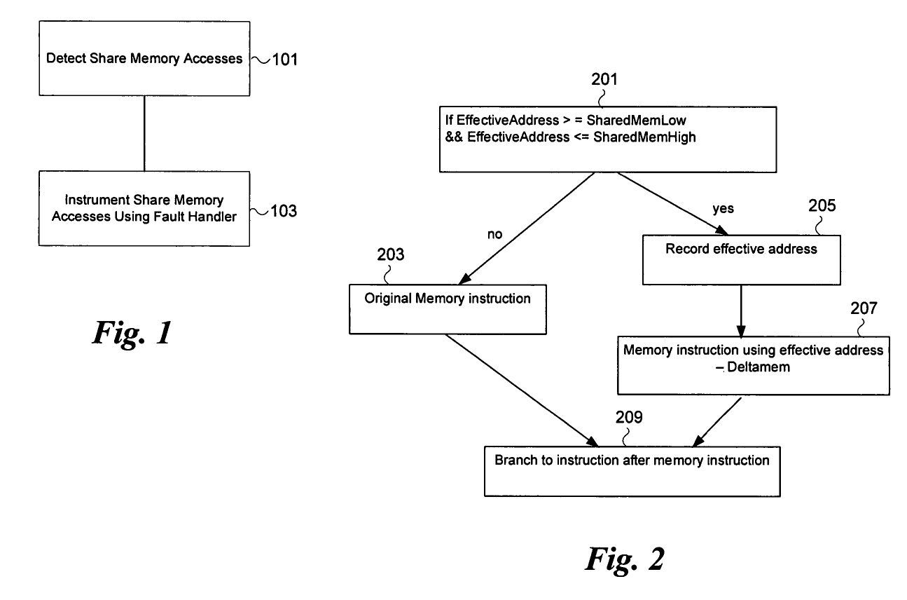

FIG. 1 is a high level flow diagram illustrating an exemplary method to instrument references to shared memory, according to an embodiment of the invention. In an embodiment, shared memory accesses are detected in block 101, prior to instrumentation. Distinguishing instructions that potentially access shared memory from instructions which never access shared memory is important. The ability to instrument only the instructions that potentially access shared memory references may enable the instrumented code to run many times faster than code instrumented with existing tools. An instruction may be identified as potentially accessing shared memory because it will fault if uninstrumented.

In one embodiment, the shared memory reference detection mechanism uses address translation. When the application makes an operating system request to map the shared memory into its address space, instrumentation is used to intercept the call. Extra code is inserted into the function that calls the operating system mapping service. The requested area may be mapped into memory without read or write permission. The actual shared memory is mapped into an alternate address, called the shadow area. The difference between the requested area and the shadow area is referred to as DeltaMem. By adding DeltaMem to a memory address, the address pointer may be translated from the requested area to the shadow area. Only shared memory references are set to point to a shadow memory area, i.e., non-existent memory locations.

Thus, because shared memory is mapped to an area that cannot be accessed, or it has no permission to access, when the program tries to reference shared memory, a memory fault occurs. The detection mechanism may register a signal handler, or fault handler, to be called 103 when a memory fault occurs. The fault handler may interpret the instruction that faulted and adds DeltaMem to the address so the shadow shared memory location will be referenced. However, if a fault occurred each time the memory was referenced, the application functions correctly, but will be very slow. References to shared memory will fault and then be emulated. It may take approximately 10000 cycles for the kernel to deliver a signal to a user process.

To speedup future accesses to shared memory by the same instruction, it may be instrumented. When a fault occurs, the system may generate a sequence of instructions. In an embodiment, the generated code tests the accessed memory address to determine whether the address is in the range of memory addresses for shared memory in block 201. If not, then the original memory instruction may be executed in block 203. Once the original instruction is executed, program control branches back to the instruction following the original memory instruction, in block 209.

If the accessed memory address falls in the range of memory addresses for shared memory, as determined in block 201, then the effective address is recorded in block 205. The tool that performs bug checking needs to see every access to shared memory. In this context, “recording” means that the reference is saved for later analysis by the bug checking tool, or the bug checking tool may immediately analyze the address. The instrumentation actions required for accesses to shared memory are performed (e.g. record the effective address and call stack). DeltaMem is subtracted from the address to determine the shadow memory address in block 207. Then the memory operation may be performed. Once the instruction is executed using the shadow memory, program control branches back to the instruction following the original memory instruction, in block 209.

In an embodiment, the first time an instruction accesses shared memory, the instrumentation system replaces the original memory instruction with a branch to the generated code and resumes execution at the branch. If the application executes the same instruction again, execution of an instrumented instruction will branch to the generated code and perform the instrumentation, if necessary, without another memory fault. Instructions that never touch the shared memory will execute without any instrumentation.

When non-shared memory is accessed, processing continues as usual, with no instrumentation overhead. Thus, the instrumentation is determined at runtime, when the exception handler is executed. Existing instrumentation tools must determine at compile time which code to instrument.

The memory fault (i.e., exception) may run 1000 times more slowly than the application code. There is significant overhead involved with accessing the operating system to handle the fault. However, because the fault only occurs the first time an instruction accesses shared memory accesses and not all memory accesses, the instrumented code is not considerably slower than the non-instrumented code compared to other instrumentation methods.

Shared memory may be at a fixed offset from the non-existent memory location. This makes it simple to translate, or map, shared memory locations from the non-existent to the actual, and vice-a-versa. New code must be generated in memory to determine whether memory is within the range of non-existent memory and if so, it is translated to the actual memory location. Also, the instrumentation is inserted to track desired information.

There are several applications of embodiments of the present invention. Any application that utilizes shared memory may take advantage of this method, such as database servers. Developers of database servers using shared memory may want to identify bugs in accesses of shared memory. They may desire to detect stale pointers in database management. In these applications, only shared memory references are of interest. Other applications using shared memory that may want to utilize embodiments of the present invention are web servers, file servers, and scientific computing using parallel programming.

Embodiments of the present system and method are performance efficient because non-shared memory accesses are not instrumented. Further, a fault may only be necessary the first time a shared memory instruction is executed. Code caching may be used to store the patched instrumentation code. A fault handler may emulate the instrumentation upon first execution of the instruction.

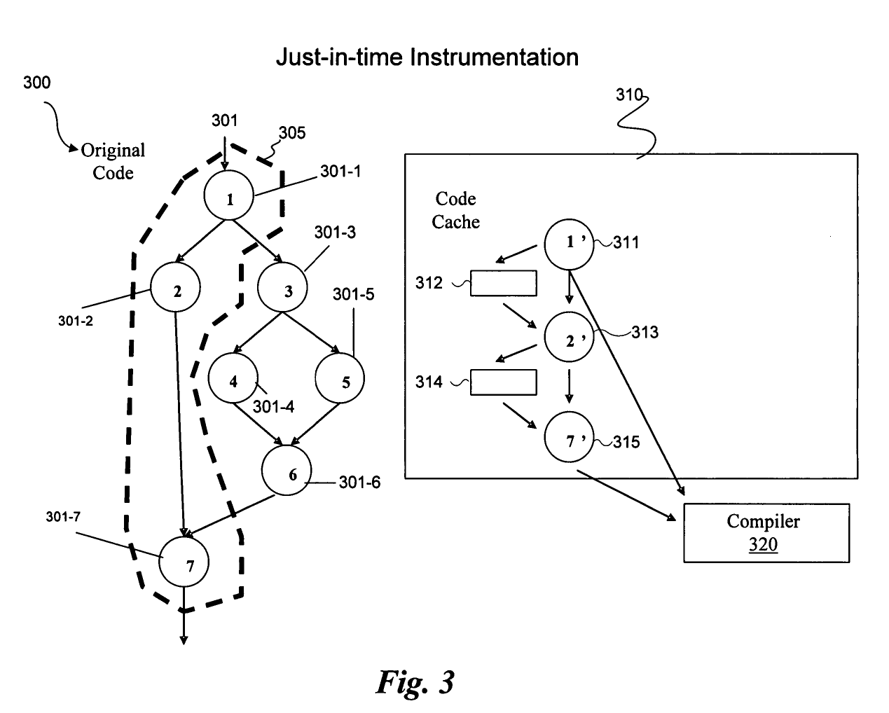

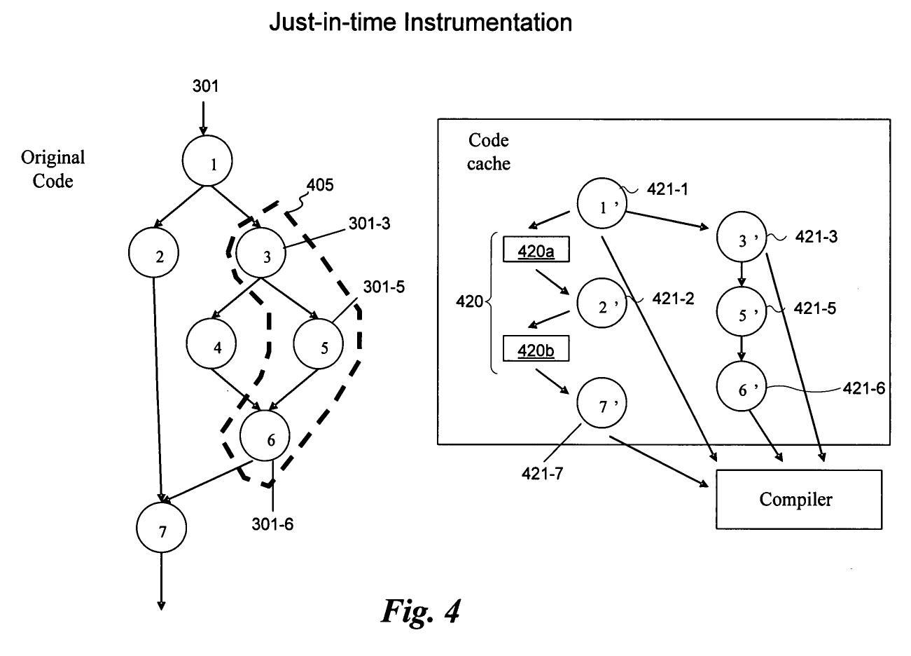

FIGS. 3 and 4 are block diagrams illustrating the use of code caching for the instrumentation. There may be implementation issues for effecting the branching (patching) for processors with varying length instructions. One embodiment implemented on a processor such as the Itanium® processor, available from Intel Corporation, has instructions of the same size. Thus, a single instruction may replace a single instruction for a branch out. However, another embodiment implemented on an IA-32 architecture processor has instructions of different sizes. In this embodiment, an instruction that is to be replaced may be shorter than the replacement branch instruction. Embodiments of the present invention may be used on all processors using code caching.

In one embodiment, the shared memory access instruction may be replaced with a branch instruction, when first accessed. If the memory access instruction is too large for the instruction size, code caching may be used to store execution threads. Instead of replacing the memory access instruction with a branch, a preceding branch instruction may be replaced with a new branch to the code cache to accommodate the branch instruction size. Thus the entire trace of the replaced branch instruction may be put in the code cache instead of merely a patch for the memory access instruction.

Instead of executing the original program from memory, control of the program is intercepted at the beginning and generates code by putting code into a buffer, or code cache. As each piece of original code would be executed, it is copied to the code cache and redirects the code execution from there. All instrumentation code is generated in the code cache. The branch instruction may be placed in the code cache, also.

To illustrate the code cache, FIG. 3 shows an example of just-in-time instrumentation of original instruction code 300. In an exemplary embodiment implemented on a processor such as the IA-32, original code 300 may have an instruction thread 301. Some of the code within thread 301 may need instrumentation. In the example shown, the thread 301 comprises instructions 1 to 7 (301-1, 301-2, 301-3, 301-4, 301-5, 301-6, and 301-7). A possible execution thread 305 comprises branch instruction 301-1, and instructions 301-2 and 301-7. In the illustrated example, instructions 301-1 and 301-2 access shared memory and require instrumentation code 312 and 314, respectively. To execute the original code with instrumentation, a code caching scheme may be used.

When instruction 301-1 is determined to have a shared memory access, the just-in-time (JIT) runtime compiler 320 predicts the most likely path of instructions and copies the thread 305 to a code cache 310. The code cache 310 now replaces the thread of instructions 1-2-7 (301-1, 301-2, and 301-7) with 1′-2′-7′ and required instrumentation to create cached instructions 311, 312, 313, 314, and 315. When instruction 1 (301-1) is to be executed, the cached code 311 is executed instead, with instrumentation 312.

In the exemplary embodiment shown in FIG. 3, if the program takes the path 1-2-7, then the code cache code will be executed. Otherwise, control branches back to the compiler for more compilation. If control is to pass to instruction 3 (301-3), then a new thread 3-5-6 may be predicted and instructions 3-5-6 are put into the code cache. Any instruction that is to be executed in the original program is copied to the code cache as for instance, 1′, 2′, etc. The instrumentation is implemented through the code cache.

FIG. 4 illustrates a second thread 405 comprising instructions 3-5-6 (301-3, 301-5, and 301-6). In one embodiment, all original code is copied to the code cache without immediately generating instrumentation. Initially, the instruction thread 1-2-7 (301-1, 301-2, and 301-7) is copied to the code cache as 1′-2′-7′ (421-1, 421-2, and 421-7). When it is known that the thread is to execute instruction 3 (301-3), instructions 3′-5′-6′ (421-3, 421-5, and 421-6) are written to the code cache.

Another layer of indirection in the code cache may be generated. For instance, a load instruction at 5′ (421-5), for instance, may access shared memory. This code may then be rewritten in the code cache with instrumentation. Instead of replacing the single instruction, the entire trace of instructions 3′-5′-6′ (421-3, 421-5, 421-6) may be replaced with the instrumentation. Individual instructions need not be replaced, but instead sequences of instructions may be replaced in the code cache. The JIT operates on compiled machine instructions, so it does not matter which programming language was used to originally develop the code.

Referring to both FIG. 3 and FIG. 4, the decision regarding when instrumentation is required is made during execution at a fault. For instance, in an embodiment, instruction thread 1-2-7 (305) is executed. In an example, execution of instruction 2 (301-2) comprises a shared memory access which causes a fault. For the first execution of this instruction, the instruction is translated in the fault handler. The branch is to instrumentation code and is emulated in the handler. A branch to instrumentation is written to the code cache for execution the next time this instruction is accessed. In this example, instruction 2 (301-2), is too short to be replaced with a branch instruction. Thus, the JIT compiler 430 may replace instruction 1′ (421-1) with a branch with 1″-2″-7″ (not shown), where instruction 2′ (421-2) is instrumented as desired.

In an embodiment, the thread 305 of instructions 1-2-7 are not expected to have shared memory references, so they are not initially instrumented. During execution, it may be discovered that 2′ (421-2) has a shared memory reference. It is desired to insert an additional branch for 2′ to branch to instrumentation. However, in an example, the instruction length of 2′ (421-2) is too short to accommodate a branch instruction. Thus, instruction 2′ (421-2) cannot be overwritten. In this case, to implement instrumentation, the entire sequence of instruction is rewritten as 1″-2″-7″. The next time instruction 1 is executed, a branch to 1″-2″-7″ (not shown) will be executed. In one embodiment, this is effected by modifying branches to instruction 1′ (421-1) with a branch to 1″ in the code cache. Since a branch is replaced with a branch, instruction size is not an issue.

As described above, in an embodiment, when an instruction accessing shared memory is executed for the first time, the instrumentation branches have not been generated. In this case, the instrumentation is performed in the fault handler and then execution resumes with the original code right after the memory instruction. The fault handler simulates the instruction and performs the instrumentation. The JIT compiler 430 copies the instruction and any necessary branch instructions to code cache so that the next time the instruction is accessed, a fault will not be required.

In another embodiment implemented on a processor such as an Itanium® processor, code cache may be used differently. Instructions may be replaced with branches which execute the instrumentation and then the original instruction using the deltamem address mapping. Patches may be placed in the original program to branch to the instrumentation. Once the instrumentation is complete, control branches back to the instruction after the instruction that accessed shared memory.

If a piece of code is only executed once then the code cache instrumentation is never used. The instrumentation for the first access is performed/emulated in the fault handler. The fault handler is more costly to access than the branch instruction to a code cache. Instrumentation is also costly, so limiting performance of the instrumentation to cases where only shared memory is accessed results in better performance.

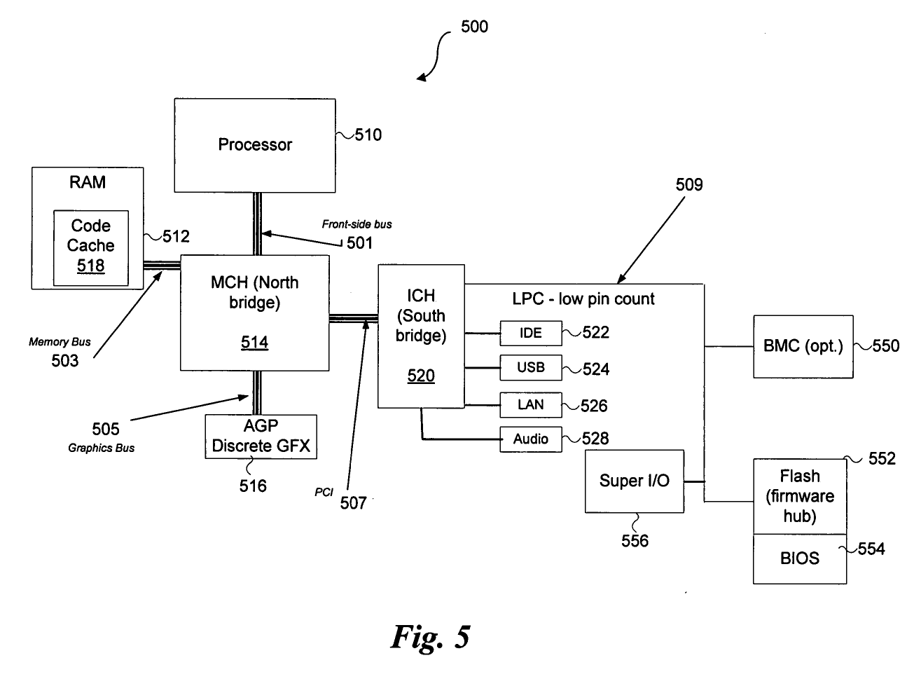

FIG. 5 is a block diagram of an exemplary system in which embodiments of the present invention may be implemented. In one embodiment, FIG. 5 shows an exemplary block diagram of a computer system 500. Processor 510 communicates with a memory controller hub (MCH) 514, also known as North bridge, via the front side bus 501. The MCH 514 communicates with system memory 512 via a memory bus 503. The MCH 514 may also communicate with an advanced graphics port (AGP) 516 via a graphics bus 505. The MCH 514 communicates with an I/O controller hub (ICH) 520, also known as South bridge, via a peripheral component interconnect (PCI) bus 507. The ICH 520 may be coupled to one or more components such as PCI hard drives (not shown), legacy components such as IDE 522, USB 524, LAN 526 and Audio 528, and a Super I/0 (SIO) controller 556 via a low pin count (LPC) bus 509.

Processor 510 may be any type of processor capable of executing software, such as a microprocessor, digital signal processor, microcontroller, or the like. Though FIG. 5 shows only one such processor 510, there may be one or more processors in platform hardware 500 and one or more of the processors may include multiple threads, multiple cores, or the like.

Memory 512 may be a hard disk, a floppy disk, random access memory (RAM), read only memory (ROM), flash memory, or any other type of medium readable by processor 510. Memory 512 may store instructions for performing the execution of method embodiments of the present invention. In an embodiment, memory 512 comprises accessible areas and inaccessible areas. Shared memory accesses may be designed to attempt access to inaccessible areas of memory to cause memory faults when executed. A code cache 518 may reside in memory 512 to be used for faster instrumentation than available using a fault handler.

Non-volatile memory, such as Flash memory 552, may be coupled to the ICH 520 via a low pin count (LPC) bus 509. The BIOS firmware 554 typically resides in the Flash memory 552 and boot up will execute instructions from the Flash, or firmware.

In some embodiments, platform 500 is a server enabling server management tasks. This platform embodiment may have a baseboard management controller (BMC) 550 coupled to the ICH 520 via the LPC 509.

The techniques described herein are not limited to any particular hardware or software configuration; they may find applicability in any computing, consumer electronics, or processing environment. The techniques may be implemented in hardware, software, or a combination of the two. The techniques may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, that may include a processor, a storage medium accessible by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various system configurations, including multiprocessor systems, minicomputers, mainframe computers, independent consumer electronics devices, and the like. The invention can also be practiced in distributed computing environments where tasks or portions thereof may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods. The term “machine accessible medium” used herein shall include any medium that is capable of storing or encoding a sequence of instructions for execution by the machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method for instrumenting shared memory accesses, comprising:
detecting a shared memory access; and
instrumenting the shared memory access using a just in time (JIT) compiler, wherein a fault handler triggers execution of the JIT.

2. The method as recited in claim 1, wherein detecting comprises:
causing the shared memory access to reference an inaccessible area of memory; and
generating a memory fault upon an attempt to access the inaccessible area of memory.

3. The method as recited in claim 2, further comprising:
mapping the shared memory access reference to a valid area of memory; and
executing instrumentation related to the shared memory access.

4. The method as recited in claim 1, wherein the fault handler emulates instrumentation for shared memory access and initiates instrumentation to be written to a code cache, the writing performed by the JIT, for execution when the shared memory access instruction is executed at another instance.

5. The method as recited in claim 4, wherein a second and subsequent executions of the instrumented shared memory access utilize the code cache and do not cause a memory fault.

6. The method as recited in claim 1, further comprising:
executing the instrumentation; and
executing the shared memory access instruction.

7. The method as recited in claim 6, wherein executing the shared memory access instruction, comprises:
translating the shared memory access instruction to a valid area of memory;
executing the translated shared memory access instruction; and
transferring control to an instruction assigned to be executed after the shared memory access instruction.

8. The method as recited in claim 7, wherein the instrumentation is a patch of instructions residing in a code cache.

9. The method as recited in claim 7, wherein the translating comprises:
determining whether the shared memory access falls within a threshold range of memory addresses;
if the shared memory access falls within the threshold range of memory addresses, recording an effective memory address; and
adding a delta constant to the effective memory address to determine a translated shared memory access instruction.

10. A system for instrumenting shared memory accesses, comprising:
a processor coupled to system memory having a code cache;
a fault handler to handle memory faults caused by an attempt to access an inaccessible area of system memory by a shared memory access instruction; and
a just in time (JIT) compiler to generate instrumentation for the shared memory access instruction,
wherein the code cache to hold instruction threads having at least one shared memory access instruction and at least one instrumentation of the at least one shared memory access instruction.

11. The system as recited in claim 10, wherein execution of a shared memory access instruction initiates the fault handler when the shared memory access instruction has not yet been executed, and wherein execution of a shared memory access instruction initiates execution of shadow code in the code cache when the shared memory access instruction has been previously executed and instrumented by the JIT compiler.

12. The system as recited in claim 10, wherein shared memory references attempting to access inaccessible areas of memory are mapped to a valid area of memory prior to execution.

13. The system as recited in claim 10, wherein the JIT compiler generates instructions to be stored in the code cache, when executed the instructions to cause the machine to:
translate the shared memory access instruction to a valid area of memory;
execute the translated shared memory access instruction; and
transfer control to an instruction assigned to be executed after the shared memory access instruction.

14. A machine accessible medium having instructions that when executed cause the machine to:
detect a shared memory access; and
instrument the shared memory access instruction with instrumentation code, wherein a fault handler triggers generation of the instrumentation code.

15. The medium as recited in claim 14, further comprising instructions that when executed cause the machine to:
cause the shared memory access to reference an inaccessible area of memory; and
generate a memory fault upon an attempt to access the inaccessible area of memory.

16. The medium as recited in claim 15, further comprising instructions that when executed cause the machine to:
map the shared memory access reference to a valid area of memory; and
execute instrumentation code related to the shared memory access.

17. The medium as recited in claim 14, wherein the fault handler emulates instrumentation code for shared memory access and initiates instrumentation code to be written to a code cache, the writing performed by a just in time compiler (JIT), for execution when the shared memory access instruction is executed at another instance.

18. The medium as recited in claim 17, wherein second and subsequent executions of the instrumented shared memory access utilize the code cache and do not cause a memory fault.

19. The medium as recited in claim 14, further comprising instructions that when executed cause the machine to:
execute the instrumentation code; and
execute the shared memory access instruction.

20. The medium as recited in claim 19, wherein executing the shared memory access instruction, comprises instructions that when executed cause the machine to:
translate the shared memory access instruction to a valid area of memory;
execute the translated shared memory access instruction; and
transfer control to an instruction assigned to be executed after the shared memory access instruction.

21. The medium as recited in claim 20, wherein the instrumentation code is a patch of instructions residing in a code cache.

22. The medium as recited in claim 20, wherein the translating further comprises instructions that when executed cause the machine to:
determine whether the shared memory access falls within a threshold range of memory addresses;
if the shared memory access falls within the threshold range of memory addresses, record an effective memory address; and
add a delta constant to the effective memory address to determine a translated shared memory access instruction.
